(19) United States
(12) Patent Application Publication
(10) Pub. No.: US 2026/0024743 A1
(43) Pub. Date: Jan. 22, 2026

(54) METHOD FOR PREPARING DRY ELECTRODE SHEET FOR SECONDARY BATTERY, CALENDERING DEVICE FOR PREPARING DRY ELECTRODE SHEET FOR SECONDARY BATTERY, DRY ELECTRODE SHEET FOR SECONDARY BATTERY, ELECTRODE FOR SECONDARY BATTERY AND SECONDARY BATTERY

(71) Applicant: SK On Co., Ltd., Seoul (KR)

(72) Inventors: Young Jun KIM, Daejeon (KR); In Ha KIM, Daejeon (KR); Min Ju JEONG, Daejeon (KR)

(21) Appl. No.: 19/242,838

(22) Filed: Jun. 18, 2025

(30) Foreign Application Priority Data
Jul. 19, 2024 (KR) 10-2024-0095852

(51) Int. Cl. H01M 4/04; B05C 1/08; B05C 1/12; H01M 4/02

(52) U.S. Cl. CPC H01M 4/0435; B05C 1/0808; B05C 1/0821; B05C 1/12; H01M 2004/021

(57) ABSTRACT

The present disclosure provides a method for preparing a dry electrode sheet for a secondary battery by allowing a composition for preparing a dry electrode sheet including an electrode active material and a binder to pass through a calendering device, a dry electrode sheet for a secondary battery prepared therefrom and a calendering device used for preparation of a dry electrode sheet for a secondary battery.

### CROSS-REFERENCE TO RELATED APPLICATION(S)

This application claims benefit of priority to Korean Patent Application No. 10-2024-0095852 filed on Jul. 19, 2024 in the Korean Intellectual Property Office, the disclosure of which is incorporated herein by reference in its entirety.

### TECHNICAL FIELD

The present disclosure generally relates to a method for preparing a dry electrode sheet for a secondary battery, a calendering device for preparing a dry electrode sheet for a secondary battery, a dry electrode sheet for a secondary battery, an electrode for a secondary battery and a secondary battery.

### BACKGROUND

A lithium secondary battery may be an energy source for a mobile device, and has been used as a power source for an electric vehicle (EV) and a hybrid electric vehicle (HEV), and demand therefor has been continuously increased.

A process of manufacturing a lithium secondary battery may include three stages, an electrode (electrode plate) process, an assembly process, and an activation process. The electrode process may include a mixing (mixing an active material) process in which an electrode composition including an active material is mixed with a solvent to manufacture an electrode mixture slurry, a coating process in which the electrode mixture slurry is coated on a current collector to form a mixture layer, a drying process in which a solvent in the mixture layer is removed, a rolling process in which the mixture layer is pressurized to form a predetermined thickness, and a slitting process in which the non-conductive portion is cut to manufacture an electrode tab.

Generally, an electrode of a lithium secondary battery may be prepared by dispersing an electrode mixture including an electrode active material and a binder in a solvent such as water or NMP (methyl pyrrolidone, N-Methyl-2-pyrrolidone) to prepare an electrode active material slurry, applying the slurry to a current collector, and drying the slurry.

In the drying process, the solvent contained in the electrode mixture slurry may be evaporated, but in the drying process of evaporating the solvent, defects such as pinholes or cracks may occur in the electrode mixture layer formed previously.

Also, since internal and external regions of the electrode mixture layer are not uniformly dried, migration in which particles float together due to a difference in evaporation rates of the solvent, that is, particles such as binders from an area which dries first move together with the evaporated solvent and rise to a surface, such that a gap from an area which dries relatively later is formed, which may deteriorate electrode quality.

To address this problem, technological development has been conducted to control an evaporation rate of a solvent while ensuring that internal and external regions of an electrode composite layer are dried uniformly. However, a drying device applied to this technology may be expensive and may require considerable costs and time to operate, which may be disadvantageous in terms of manufacturing processability.

Meanwhile, a method for preparing a dry electrode has been suggested to address deterioration of electrode quality and manufacturing processability issues.

### SUMMARY

According to an aspect of the present disclosure, provided are a method for preparing a dry electrode sheet for a secondary battery, a calendering device for preparing a dry electrode sheet for a secondary battery, a dry electrode sheet for a secondary battery, an electrode for a secondary battery and a secondary battery.

According to an embodiment of the present disclosure, a method for preparing a dry electrode sheet for a secondary battery includes preparing a dry electrode sheet by allowing a composition for preparing a dry electrode sheet, including an electrode active material and a binder, to pass through a calendering device, wherein the calendering device includes a plurality of rolls, wherein the calendering device has two or more inter-roll gaps (G) provided by two rolls (Ra and Rb) adjacent to each other among the rolls, through which the composition passes sequentially, wherein the two rolls (Rna and Rnb) adjacent to each other and providing the nth inter-roll gap (Gn) have a velocity (V) ratio of 10% or more to less than 50%, represented by Equation (1):

$$Velocity ratio = [ V ( R n a ) - V ( R n b ) ] \times 100 / V ( R n b ) \qquad [ Equation ( 1 ) ]$$

where Rna indicates a roll further from a point at which the composition is injected, and Rnb indicates a roll closer to a point at which the composition is injected,

As for the nth inter-roll gap (Gn) and the n+1th inter-roll gap (Gn+1), a reduction ratio between Gn and Gn+1 represented by Equation (2) as below may be more than 10% to less than 50%:

$$Reduction ratio between Gn and Gn + 1 = [ ( G n ) - ( G n + 1 ) ] \times 100 / Gn \qquad [ Equation ( 2 ) ]$$

where Gn indicates an inter-roll gap between rolls provided on a side closer to a point at which the composition is injected, and Gn+1 indicates an inter-roll gap between rolls provided on a side farther from a point at which the composition is injected.

A temperature of the rolls may be greater than 50° C. and less than 120° C.

The velocity ratio may be 10% to 40%.

The inter-roll gaps of the calendering device may be independently 70 μm or more and 200 μm or less.

A diameter of each of the plurality of rolls may be independently 200 μm to 300 μm.

A dry electrode sheet for a secondary battery according to another aspect of the present disclosure may be prepared by the preparing method as above.

The electrode sheet may have a thickness of 100 μm to 200 μm.

An electrode sheet for a secondary battery according to another embodiment of the present disclosure may include a current collector, and a dry electrode sheet for a secondary battery provided on the current collector.

The electrode sheet may be a thickness of 100 μm to 200 μm.

The electrode may be a negative electrode or a positive electrode.

According to another embodiment of the present disclosure, a secondary battery may be configured as a secondary battery including an electrode assembly including a positive electrode, a separator and a negative electrode, and an electrolyte contained and sealed within a battery case, wherein at least one of the positive electrode and the negative electrode may be the electrode.

According to another embodiment of the present disclosure, a calendering device for preparing a dry electrode sheet for a secondary battery includes a plurality of rolls, wherein the dry electrode sheet is prepared by allowing a composition for preparing a dry electrode sheet, including an electrode active material and a binder, to pass through the plurality of rolls, wherein the calendering device has two or more inter-roll gaps (G) provided by two rolls (Ra and Rb) adjacent to each other among the rolls, through which the composition passes sequentially, wherein the two rolls (Rna and Rnb) adjacent to each other and providing the nth inter-roll gap (Gn) have a velocity (V) ratio of 10% or more to less than 50%, represented by Equation (1):

$$Velocity ratio = [ V ( R n a ) - V ( R n b ) ] \times 100 / V ( R n b ) \qquad [ Equation ( 1 ) ]$$

where Rna indicates a roll further from a point at which the composition is injected, and Rnb indicates a roll closer to a point at which the composition is injected,

As for the nth inter-roll gap (Gn) and the n+1th inter-roll gap (Gn+1), a reduction ratio between Gn and Gn+1 represented by Equation (2) as below may be more than 10% to less than 50%:

$$Reduction ratio between Gn and Gn + 1 = [ ( G n ) - ( G n + 1 ) ] \times 100 / Gn \qquad [ Equation ( 2 ) ]$$

where Gn indicates an inter-roll gap provided on a side closer to a point at which the composition is injected, and Gn+1 indicates an inter-roll gap provided on a side farther from a point at which the composition is injected.

A temperature of the rolls may be greater than 50° C. and less than 120° C.

The velocity ratio may be 10% to 40%.

The inter-roll gaps of the calendering device may be independently 70 μm or more and 200 μm or less.

A diameter of each of the plurality of rolls may be independently 200 μm to 300 μm.

### BRIEF DESCRIPTION OF DRAWINGS

Predetermined aspects, features, and advantages of the present disclosure are illustrated by the following detailed description with reference to the accompanying drawings.

FIG. 1 is a diagram illustrating a calendering process according to a preferable embodiment of the present disclosure;

FIG. 2 is an image of a composition for manufacturing a dry electrode sheet prepared according to embodiment 1 of the present disclosure, obtained by an electron microscope;

FIG. 3 is a diagram illustrating slipping of an electrode sheet during a calendering process;

FIG. 4 is an image of slipping of an electrode sheet during a calendering process; and

FIG. 5 is a diagram illustrating adhesion of an electrode sheet to a roll during a calendering process.

### DETAILED DESCRIPTION

The embodiments of the present disclosure are illustrated in embodiments with

reference to the accompanying drawings. The embodiments may be modified in different forms and may not be limited to the embodiments described below.

A method for preparing a dry electrode sheet for a secondary battery according to a preferable embodiment may be described. The method for preparing a dry electrode sheet for a secondary battery may include preparing a dry electrode sheet by allowing a composition for preparing a dry electrode sheet including an electrode active material and a binder to pass through a calendering device.

The composition for preparing a dry electrode sheet may include an electrode active material and a binder, and may include a small amount of solvent if desired. The composition for preparing a dry electrode sheet including powder components not including a solvent may be mixed using a device such as a blender such that the binder to may be evenly distributed with the electrode active material.

The method for preparing a dry electrode sheet for a secondary battery according to the present disclosure may be applied to both the preparing of a positive electrode sheet and a negative electrode sheet. Accordingly, the electrode active material may be a positive electrode active material or a negative electrode active material.

For example, when the electrode to be prepared is a negative electrode, a material for adsorbing and desorbing lithium ions may be used as the negative electrode active material. For example, the negative electrode active material may be a carbon-based material such as crystalline carbon, amorphous carbon, carbon composite, carbon fiber; lithium metal; lithium alloy; silicon (Si)-containing material or tin (Sn)-containing material.

Examples of amorphous carbon may include hard carbon, soft carbon, coke, mesocarbon microbead (MCMB), mesophase pitch-based carbon fiber (MPCF), or the like.

Examples of crystalline carbon may include graphite carbon such as natural graphite, artificial graphite, graphitized coke, graphitized MCMB, and graphitized MPCF.

Lithium metal may be pure lithium metal or lithium metal having a protective layer formed thereon for suppressing dendrite growth, or the like.

The elements included in the lithium alloy may include aluminum, zinc, bismuth, cadmium, antimony, silicon, lead, tin, gallium, or indium.

The silicon-containing material may provide increased capacity properties. The silicon-containing material may include Si, SiOx(0<x<2), metal doped SiOx(0<x<2), silicon-carbon composite, or the like. The metal may include lithium and/or magnesium, and the metal doped SiOx(0<x<2) may include metal silicate.

In the negative electrode, the content of the negative electrode active material may be 94 to 98 weight % based on the total weight of the composition for preparing a dry electrode sheet.

When the electrode to be prepared is a positive electrode, the positive electrode active material may include a compound for reversibly intercalating and deintercalating lithium ions.

According to example embodiments, the positive electrode active material may include a lithium-nickel metal oxide. The lithium-nickel metal oxide may further include at least one of cobalt (Co), manganese (Mn) or aluminum (Al).

In some embodiments, the positive electrode active material or the lithium-nickel metal oxide may include a layered structure or a crystal structure represented by chemical formula 1 as below.

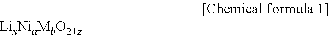

In chemical formula 1, 0.9≤x≤1.2, 0.6≤a≤0.99, 0.01≤b≤0.4, −0.5≤z≤0.1 may be satisfied. As described above, M may include Co, Mn, and/or Al.

The chemical structure represented by chemical formula 1 may represent a bonding relationship included in a layered structure or a crystal structure of a positive electrode active material and may not exclude other additional elements. For example, M includes Co and/or Mn, and Co and/or Mn may be provided as a main active element of the positive electrode active material together with Ni. Chemical formula 1 may be provided to represent the bonding relationship between the main active elements and may be understood as a formula encompassing addition and substitution of additional elements.

In a preferable embodiment, auxiliary elements may be further included in addition to the main active element to enhance chemical stability of the positive electrode active material or the layered structure/crystal structure. The auxiliary element may be incorporated into the layered structure/crystal structure and may form a bond, and in this case, the auxiliary element may be understood as being included within the chemical structure range represented by chemical formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P or Zr. The auxiliary element may also function as an auxiliary active element contributing to capacity/output activity of the positive electrode active material together with Co or Mn, such as Al.

For example, the positive electrode active material or the lithium-nickel metal oxide may include a layered structure or a crystal structure represented by chemical formula 1-1 as below.

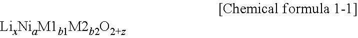

In chemical formula 1-1, M1 may include Co, Mn, and/or Al. M2 may include the auxiliary elements described above. In chemical formula 1-1, 0.9≤x≤1.2, 0.6≤a≤0.99, 0.01≤b1+b2≤0.4, −0.5≤z≤0.1 may be satisfied.

The positive electrode active material may further include a coating element or a doping element. For example, elements substantially the same as or similar to the auxiliary elements described above may be used as a coating element or a doping element. For example, the elements described above may be used alone or two or more elements may be used in combination as the coating element or the doping element.

The coating element or doping element may be present on the surface of the lithium-nickel metal oxide particle, or may penetrate through the surface of the lithium-nickel metal oxide particle and may be included in the bonding structure represented by chemical formula 1 or chemical formula 1-1.

The positive electrode active material may include a nickel-cobalt-manganese (NCM) lithium oxide. In this case, an NCM lithium oxide including increased nickel content may be used.

Ni may be provided as a transition metal related to output and capacity of a lithium secondary battery. Accordingly, by employing a high content (high-Ni) composition in the positive electrode active material as described above, a high capacity positive electrode and a high capacity lithium secondary battery may be provided.

However, as the Ni content increases, long-term storage stability and lifespan stability of the positive electrode or the secondary battery may be relatively deteriorated, and side reactions with the electrolyte may also increase. However, according to example embodiments, by including Co, electrical conductivity may be maintained, and lifespan stability and capacity retention properties may be improved through Mn.

The content of Ni (e.g., a mole fraction of nickel in the total number of moles of nickel, cobalt, and manganese) in the NCM-based lithium oxide may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the positive electrode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the positive electrode active material may include a manganese-rich active material, a lithium rich layered oxide (LLO)/overlithiated layered oxide (OLO)-based active material, or a cobalt-less active material having a chemical structure or a crystal structure represented by chemical formula 2, for example.

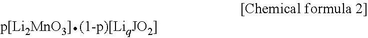

In chemical formula 2, 0<p<1 and 0.9≤q≤1.2 may be satisfied, and J may include at least one element from among Mn, Ni, Co, Fe, Cr, V, Cu, Zn, Ti, Al, Mg or B.

In the positive electrode, the positive electrode active material may be 90 to 98 weight % based on the total amount of the dry positive electrode composition.

The composition for preparing a dry electrode sheet may include a binder. As the binder, for example, a binder commonly used in electrode preparation may be used, and is not limited to any particular example, and may include, for example, polyvinylidenefluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR), or the like. In a preferable embodiment, styrene-butadiene rubber (SBR)-based binder, carboxymethyl cellulose (CMC), polyacrylic acid-based binder, poly(3,4-ethylenedioxythiophene), PEDOT-based binder, or the like, may be used as a negative electrode binder, and PVDF-based binder may be used as a positive electrode binder.

The binder may be included in a content of 1 to 5 weight % with respect to the composition for preparing a dry electrode sheet. For example, the binder may be included in a content of 1 weight % or more, 1.5 weight % or more, or 2 weight % or more, and may be included in a content of 5 weight % or less, 4.5 weight % or less, or 4 weight % or less. When the content of the binder is less than 1 weight %, the bonding force between the electrode active materials may be insufficient, and when the content exceeds 5 weight %, electrode resistance may excessively increase.

The composition for preparing a dry electrode sheet may further include a conductive material to improve conductivity if desired. As the conductive material, any material commonly used in a secondary battery may be used without limitation, and the conductive material may include, for example, carbon-based conductive materials such as graphite, carbon black, acetylene black, Ketjen black, graphene, carbon nanotube, vapor-grown carbon fiber (VGCF), or carbon fiber, and/or metal-based conductive materials including perovskite materials such as tin, tin oxide, titanium oxide, LaSrCoO₃, or LaSrMnO₃. The conductive material is not limited thereto, and may be included in an amount of, for example, 0.5 to 3 weight % with respect to the entire composition for preparing a dry electrode sheet.

The method for preparing a composition for preparing a dry electrode sheet according to a preferable embodiment may include mixing a composition for preparing a dry electrode sheet including an electrode active material and a binder as described above. Accordingly, the electrode active material, the binder, and the conductive material, added if desired, may be evenly distributed.

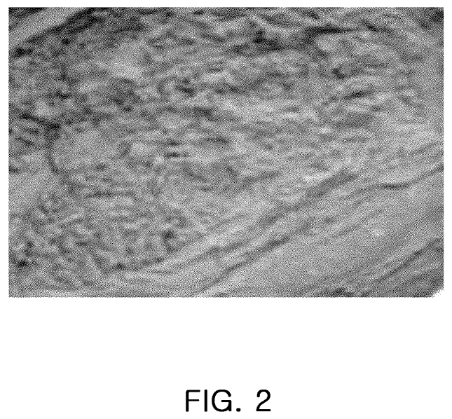

The mixing is not particularly limited, and a method for mixing solid powder may be applied in this embodiment, and for example, a blender, a mixer, or the like, may be used. The mixing conditions are not particularly limited as long as the powder included in the composition for preparing a dry electrode sheet is able to be mixed. As a preferable embodiment of the composition for preparing a dry electrode sheet prepared by the above method, an image of a composition for preparing a dry negative electrode sheet prepared by mixing an electrode active material (negative electrode active material), a binder, and a conductive material using a blender without a solvent is presented in FIG. 2.

According to a preferable embodiment, the method may include preparing a dry electrode sheet by allowing a composition including the electrode active material and the binder to pass through a calendering device, and the calendering device may include a plurality of rolls. As for the plurality of rolls, an inter-roll gap (G) provided by two rolls (Ra and Rb) adjacent to each other among the rolls, through which the composition passes sequentially, and the two rolls (Rna and Rnb) adjacent to each other and providing the nth inter-roll gap (Gn) may have a velocity (V) ratio of 10% or more to less than 50%, represented by Equation (1). Also, as for the nth inter-roll gap (Gn) and the n+1th inter-roll gap (Gn+1), a reduction ratio between Gn and Gn+1 represented by Equation (2) as below may be more than 10% to less than 50%.

$$Velocity ratio = [ V ( R n a ) - V ( R n b ) ] \times 100 / V ( R n b ) \qquad [ Equation ( 1 ) ]$$

(In Equation (1), Rna indicates a roll further from a point at which the composition is injected, and Rnb indicates a roll closer to a point at which the composition is injected.)

$$Reduction ratio between Gn and Gn + 1 = [ ( G n ) - ( G n + 1 ) ] \times 100 / Gn \qquad [ Equation ( 2 ) ]$$

(In Equation (2), Gn indicates an inter-roll gap provided on the side closer to a point at which the composition is injected, and Gn+1 indicates an inter-roll gap provided on the side farther from a point at which the composition is injected.)

The calendering device may include a plurality of rolls, and specifically, the plurality of rolls may be spaced apart from each other by a predetermined distance and may be arranged in sequence, and each may independently rotate in clockwise or counterclockwise directions. The plurality of rolls included in the calendering device may be two or more rolls, and specifically, may include two, three, four, or five rolls, or may include more rolls. The diameter of each of the plurality of rolls may, although not limited thereto, independently be 50 μm to 500 μm, specifically, 100 μm to 400 μm, and more specifically, 200 μm to 300 μm. By injecting the composition for preparing a dry electrode sheet between two rotating rolls and applying pressure using the two rolls, the composition for preparing a dry electrode sheet may be prepared in a sheet form. When the diameter of at least one roll among the plurality of rolls is less than 50 μm, a contact area with the composition for preparing a dry electrode sheet may be insufficient, such that it may be difficult to form a sheet form, and when the diameter of at least one roll among the plurality of rolls exceeds 500 μm, the contact area may increase, such that the composition for preparing a dry electrode sheet may receive excessive pressure.

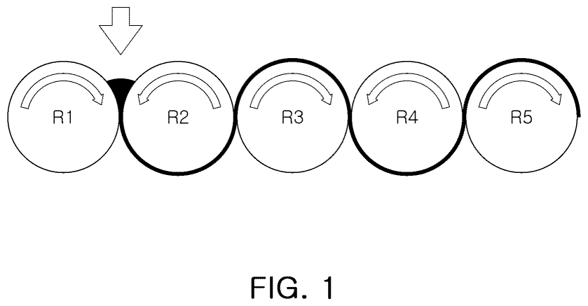

As a preferable embodiment, the calendering device may include five rolls, first to fifth rolls, and the composition for preparing a dry electrode sheet may be calendered by the first roll and the second roll, may be calendered by the second roll and the third roll, and may be calendered by the third roll and the fourth roll. This calendering process is schematically illustrated in FIG. 1.

Referring to FIG. 1, in a preferable embodiment, a first electrode sheet may be prepared in the form of a sheet by calendering the composition for preparing a dry electrode sheet between the first roll and the second roll, a second electrode sheet may be prepared by calendering the first electrode sheet between the second roll and the third roll, a third electrode sheet may be prepared by calendering the second electrode sheet between the third roll and the fourth roll, and a dry electrode sheet may be prepared by calendering the third electrode sheet between the fourth roll and the fifth roll.

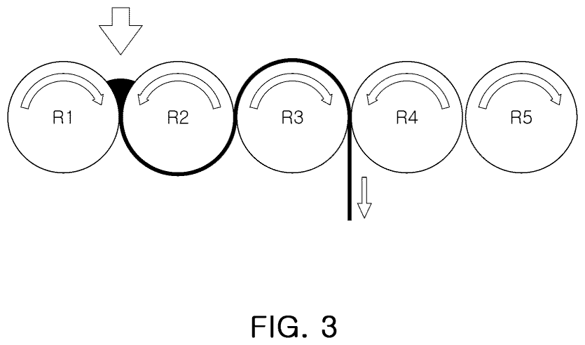

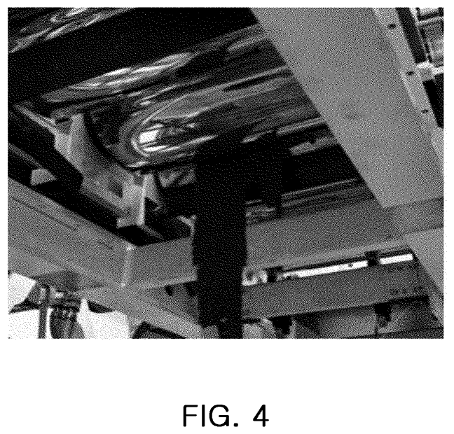

In a preferable embodiment, an inter-roll gap (G) provided by two rolls (Ra and Rb) adjacent to each other among the plurality of rolls, through which the composition for preparing a dry electrode sheet or the electrode sheet passes in sequence, the two rolls (Rna and Rnb) adjacent to each other and providing the nth inter-roll gap (Gn) may have a velocity (V) ratio of 10% or more to less than 50%, represented by Equation (1), specifically 10% or more to 49.99% or less, more specifically, 10% or more to 49% or less, and even more specifically, 10% to 40%. Here, the velocity (V) of each roll may indicate a rotational velocity of each roll, and when the velocity ratio is less than 10%, it may not be easy to control the composition for preparing a dry electrode sheet or the pressure applied to the electrode sheet, such that thickness control may be difficult or the electrode sheet may be damaged. When the velocity ratio is 50% or more, the electrode sheet having passed through two or more rolls may not be inserted between the rolls prepared thereafter and may slip and fall out. The electrode sheet slipping is presented in FIGS. 3 and 4.

$$Velocity ratio = [ V ( R n a ) - V ( R n b ) ] \times 100 / V ( R n b ) \qquad [ Equation ( 1 ) ]$$

In Equation (1), Rna indicates a roll further from a point at which the composition is injected, and Rnb indicates a roll closer to a point at which the composition is injected,

Referring to FIG. 1, in a preferable embodiment, first (n=1) to fourth (n=4) inter-roll gaps (G) may be formed between a first roll R1 and a second roll R2, between a second roll R2 and a third roll R3, between a third roll R3 and a fourth roll R4, and between a fourth roll R4 and a fifth roll R5, respectively. Here, the first and second rolls adjacent to each other and providing a first (n=1) inter-roll gap may correspond to R1a and R1b, respectively, second and third rolls adjacent to each other and providing a second (n=2) inter-roll gap may correspond to R2a and R2b, respectively, third and fourth rolls adjacent to each other and providing a third (n=3) inter-roll gap may correspond to R3a and R3b, respectively, and fourth and fifth rolls adjacent to each other and providing a fourth (n=4) inter-roll gap may correspond to R4a and

R4b, respectively. Also, the velocity ratios between the first roll and the second roll, between the second roll and the third roll, between the third roll and the fourth roll, and between the fourth roll and the fifth roll may have the same or different values within a range of 10% or more to less than 50%. Specifically, as for the first roll and the second roll, the second roll may rotate faster within a range of 10% or more to less than 50% as compared to the first roll. As for the second roll and the third roll, the third roll may rotate faster within a range of 10% or more to less than 50% as compared to the second roll. As for the third roll and the fourth roll, the fourth roll may rotate faster within a range of 10% or more to less than 50% as compared to the third roll. As for the fourth roll and the fifth roll, the fifth roll may rotate faster within a range of 10% or more to less than 50% as compared to the fourth roll.

The rolls may be spaced apart from each other by a predetermined distance. The distance between the rolls (hereinafter, the inter-roll gap) may, although not limited thereto, be independently at 50 to 500 μm, specifically at 50 to 300 μm, and more specifically at 70 to 200μm. When the inter-roll gap is less than 50 μm, electrode rolling may occur due to excessive pressure and density of the electrode may excessively increase, and when the inter-roll gap exceeds 500 μm, the pressure provided to the electrode sheet may be insufficient, such that thickness control may be difficult, and the distribution of the electrode active material, binder, and conductive material in the direction of the electrode thickness may become uneven.

In a preferable embodiment, as for the nth inter-roll gap (Gn) and the n+1th inter-roll gap (Gn+1), the reduction ratio between Gn and Gn+1 represented by Equation (2) as below may be more than 10% to less than 50%, specifically 10.01% or more to 49.99% or less, more specifically 11% or more to 49% or less, even more specifically 20% or more to 40% or less, and even more specifically 25% or more to 35% or less. When the reduction ratio between Gn and Gn+1 is 10% or less, it may be difficult to control the thickness of the prepared electrode sheet, or the electrode sheet having passed through two or more rolls may not be inserted between the rolls prepared thereafter and may slip and fall out. When the reduction ratio between Gn and Gn+1 is 50% or more, pressure may not be applied evenly to the prepared electrode sheet, which may cause damage to at least a portion of the electrode sheet.

$$Reduction ratio between Gn and Gn + 1 = [ ( G n ) - ( G n + 1 ) ] \times 100 / Gn \qquad [ Equation ( 2 ) ]$$

(In Equation (2), Gn indicates an inter-roll gap provided on the side closer to a point at which the composition is injected, and Gn+1 indicates an inter-roll gap provided on the side farther from a point at which the composition is injected.)

Referring to FIG. 1, in a preferable embodiment, the first (n=1) to fourth (n=4) inter-roll gap (G) may be formed between the first roll and the second roll, between the second roll and the third roll, between the third roll and the fourth roll, and between the fourth roll and the fifth roll, respectively. Here, first and second rolls adjacent to each other may provide the first (n=1) inter-roll gap (G1), second and third rolls adjacent to each other may provide the second (n=2) inter-roll gap (G2), third and fourth rolls adjacent to each other may provide the third (n=3) inter-roll gap (G3, and fourth and fifth rolls adjacent to each other may provide the fourth (n=4) inter-roll gap (G4). As the inter-roll gaps between other rolls adjacent to each, the reduction ratio between G1 and G2, the reduction ratio between G2 and G3, and the reduction ratio between G3 and G4 may have the same or different values in the range of more than 10% to less than 50%. Specifically, as for G1 and G2, G2 may have a smaller gap value between rolls in the range of more than 10% to less than 50% as compared to G1. As for G2 and G3, G3 may have a smaller gap value between rolls in the range of more than 10% to less than 50% as compared to G2. As for G4 and G3, G4 may have a smaller gap value between rolls in the range of more than 10% to less than 50% as compared to G3.

By applying heat and pressure to the composition for preparing a dry electrode sheet or the electrode sheet, the calendering device may prepare a dry electrode sheet in which electrode active material, binder, and conductive material are evenly distributed and which is a self-standing type.

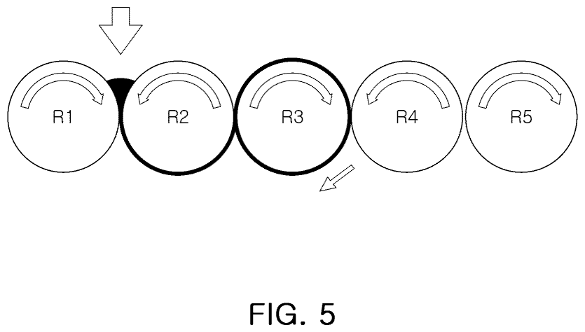

Heat may be provided by heating each roll included in the calendar roll to a predetermined temperature range. The heating temperature of the rolls may be, but is not limited to, 50° C. or higher, specifically, more than 50° C. to less than 120° C., and more specifically, 60° C. to 110° C. When the temperature of the rolls is less than 50° C., the electrode sheets having exited two or more rolls may not be inserted between the rolls prepared thereafter and may slip and fall out, or pressure may not be evenly applied to the prepared electrode sheets, such that at least a portion of the electrode sheet may be damaged. When the temperature of the rolls is 120° C. or higher, the electrode sheets having exited two or more rolls may adhere to the rolls. The slipping of the electrode sheets is presented in FIGS. 3 and 4, and the adhesion of the electrode sheet to the rolls is presented in FIG. 5.

According to another aspect of the present disclosure, a dry electrode sheet for a secondary battery prepared by the method for preparing a dry electrode sheet for a secondary battery may be provided. The description of the electrode active material, conductive material, and binder overlapping the description of the method for preparing a dry electrode sheet for a secondary battery may not be provided.

In a preferable embodiment, a thickness of the electrode sheet may be, although not limited thereto, 100 to 500 μm, specifically 100 to 300 μm, and more specifically 200 to 300 μm. When the thickness of the electrode sheet is less than 100 μm, tensile strength of the electrode sheet may be insufficient, breakage may occur, and when the thickness exceeds 500 μm, the composition component included in the electrode may be unevenly distributed in the thickness direction of the electrode sheet. Here, the thickness of the electrode sheet may indicate a final thickness of the electrode sheet. The final thickness of the electrode sheet may be the thickness of the electrode sheet prepared by the calendering process, and may be the thickness of the prepared electrode sheet obtained by allowing the composition for preparing a dry electrode sheet to pass through the gap between two or more rolls.

Also, according to another aspect of the present disclosure, an electrode including the above-described dry electrode sheet may be provided. Specifically, the electrode may include a current collector, and the dry electrode sheet provided on the current collector. The electrode may be prepared by positioning the dry electrode sheet on at least one surface of the current collector and heating and pressurizing the sheet.

The thickness of the electrode sheet included in the electrode may be, although not limited thereto, 100 to 500 μm, specifically 100 to 300 μm, and more specifically 200 to 300μm. When the thickness of the electrode sheet is less than 100 μm, tensile strength of the electrode sheet may be insufficient and breakage may occur, and when the thickness exceeds 500 μm, the composition components included in the electrode may be distributed unevenly in the thickness direction of the electrode sheet.

The electrode may be a negative electrode or a positive electrode.

The current collector included in the electrode is not particularly limited as long as the current collector has high conductivity and does not cause chemical changes in the battery.

For example, when the electrode is a positive electrode, the positive electrode current collector may include, although not particularly limited thereto, stainless steel, nickel, aluminum, titanium, or an alloy thereof. The positive electrode current collector may include aluminum surface-treated with carbon, nickel, titanium, or silver, or stainless steel surface-treated with carbon, nickel, titanium, or silver. Also, the positive electrode current collector may be a polymer substrate coated with a conductive metal such as nickel, aluminum, titanium, or silver. Also, the positive electrode current collector may have various forms, such as foil, foam, net, porous body, or nonwoven body, as non-limiting examples. Also, the positive electrode current collector may have a thickness of 10 to 50 μm, but an example embodiment thereof is not limited thereto.

Also, when the electrode is a negative electrode, the negative electrode current collector may include, although not particularly limited thereto, stainless steel, copper, nickel, titanium, or an alloy thereof. The negative electrode current collector may include copper surface-treated with carbon, nickel, titanium, or silver, or stainless steel surface-treated with carbon, nickel, titanium, or silver. Also, the negative electrode current collector may be a polymer substrate coated with a conductive metal such as nickel, aluminum, titanium, or silver. Also, the negative electrode current collector may have various forms, such as a foil, a foam, a net, a porous body, or a nonwoven body, as non-limiting examples. Also, the negative electrode current collector may have a thickness of 10 to 50 μm, but an example embodiment thereof is not limited thereto.

Furthermore, according to another aspect of the present disclosure, an electrode current collector including a positive electrode, a separator, and a negative electrode, and a secondary battery in which an electrolyte is contained and sealed within a battery case may be provided, wherein at least one of the positive electrode and the negative electrode is the electrode described above. Specifically, a secondary battery may be prepared by stacking a positive electrode and a negative electrode in order with a separator as a boundary, and storing and sealing the electrode assembly in a battery case together with an electrolyte.

According to example embodiments, the positive electrode, the negative electrode, and the separator may be repeatedly arranged, thereby forming an electrode assembly. In some embodiments, the electrode assembly may be a winding type, a stacking type, a zigzag folding type, or a stack-folding type.

The separator may be configured to prevent an electrical short circuit between the positive electrode and the negative electrode and to allow ion flow. As a preferable embodiment, the thickness of the separator may be, for example, 10 μm to 20 μm, but an example embodiment thereof is not limited thereto.

For example, the separator may include a porous polymer film or a porous nonwoven fabric. The porous polymer film may include a polyolefin polymer such as an ethylene polymer, a propylene polymer, an ethylene/butene copolymer, an ethylene/hexene copolymer, and an ethylene/methacrylate copolymer. The porous nonwoven fabric may include a high-melting point glass fiber, a polyethylene terephthalate fiber, or the like. The separator may include a ceramic material. For example, inorganic particles may be coated on the polymer film or may be dispersed within the polymer film and may improve heat resistance.

The separator may have a single-layer or multilayer structure including the above-described polymer film and/or nonwoven fabric.

An electrolyte may be accommodated within the battery case together with the electrode assembly, thereby defining a lithium secondary battery. According to preferable embodiments, the electrolyte may be a non-aqueous electrolyte.

The non-aqueous electrolyte may include a lithium salt as an electrolyte and an organic solvent, and the lithium salt may be represented as, for example, Li⁺X⁻, and examples of the anion (X⁻) of lithium salt may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)PF⁻, (CF₃)₆P⁻, CF₃SO₃⁻; CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻.

The organic solvent may include an organic compound having sufficient solubility for the lithium salt and additive and not having reactivity within the battery. As the organic solvent, for example, at least one of a carbonate solvent, an ester solvent, an ether solvent, a ketone solvent, an alcohol solvent, and an aprotic solvent may be included. As the organic solvent, for example, propylene carbonate (PC), ethylene carbonate (EC), butylene carbonate, diethyl carbonate (DEC), dimethyl carbonate (DMC), ethyl methyl carbonate (EMC), methylpropyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF) and 2-methyltetrahydrofuran, ethyl alcohol, isopropyl alcohol, dimethyl sulfuroxide, acetonitrile, dimethoxyethane, diethoxyethane, sulfolane, gamma-butyrolactone, and propylene sulfite may be used. The materials may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, and a borate compound.

The cyclic carbonate compound may include vinylene carbonate (VC), vinyl ethylene carbonate (VEC), or the like.

The fluorine-substituted carbonate compound may include fluoroethylene carbonate (FEC), or the like.

The sultone compound may include 1,3-propane sultone, 1,3-propene sultone, 1,4-butane sultone, or the like.

The cyclic sulfate compound may include 1,2-ethylene sulfate, 1,2-propylene sulfate, or the like.

The cyclic sulfite compound may include ethylene sulfite, butylene sulfite, or the like.

The phosphate compound may include lithium difluoro bis-oxalato phosphate, lithium difluoro phosphate, or the like.

The borate compound may include lithium bis (oxalate) borate, or the like.

The secondary battery may have electrode tabs (positive electrode tab and negative electrode tab) protruding from the positive electrode current collector and the negative electrode current collector, respectively, and extending to one side portion of the battery case. For example, the battery case may be a pouch-shaped case, a square case, a cylindrical case, a coin-shaped case, or the like.

The electrode tabs may extend or may be exposed externally from one side portion of the battery case, for example, and may be connected to the electrode leads (a positive electrode lead and a negative electrode lead). When the battery case is a pouch-type case, the electrode tabs extending externally from one side portion of the battery case may be fused together with the battery case.

Furthermore, a secondary battery module may be configured using a secondary battery according to the present disclosure, and further, by packaging one or more of the modules within a pack case, a secondary battery pack may be formed.

The above-described secondary battery module and a secondary battery pack including the same may be applied to various devices, and specifically, may be applied to various devices which may use a secondary battery module and a secondary battery pack including the same, and an embodiment thereof is not limited thereto, and the above-described secondary battery module and a secondary battery pack including the same may be applied to means of transportation such as an electric bicycle, an electric car, and a hybrid car, for example.

Furthermore, according to another aspect of the present disclosure, as a calendering device for preparing a dry electrode sheet for a secondary battery, the calendering device may include a plurality of rolls, and the dry electrode sheet may be prepared by allowing a composition for preparing a dry electrode sheet including an electrode active material and a binder to pass through the plurality of rolls, the calendering device has two or more inter-roll gaps (G) provided by two rolls (Ra and Rb) adjacent to each other among the plurality of rolls, through which the composition passes sequentially, and the two rolls (Rna and Rnb) adjacent to each other and providing the nth inter-roll gap (Gn) may have a velocity (V) ratio of 10% or more to less than 50%, represented by Equation (1).

$$Velocity ratio = [ V ( R n a ) - V ( R n b ) ] \times 100 / V ( R n b ) \qquad [ Equation ( 1 ) ]$$

In Equation (1), Rna indicates a roll further from a point at which the composition is injected, and Rnb indicates a roll closer to a point at which the composition is injected,

A calendering device in which a reduction ratio between Gn and Gn+1, represented by Equation (2) as below may be more than 10% to less than 50% as for the nth inter-roll gap (Gn) and the n+1th inter-roll gap (Gn+1) may be provided.

$$Reduction ratio between Gn and Gn + 1 = [ ( G n ) - ( G n + 1 ) ] \times 100 / Gn \qquad [ Equation ( 2 ) ]$$

In Equation (2), Gn indicates an inter-roll gap provided on the side closer to a point at which the composition is injected, and Gn+1 indicates an inter-roll gap provided on the side farther from a point at which the composition is injected.

The temperature of the rolls in the calendering device may be more than 50° C. to less than 120° C.

The velocity speed ratio in the calendering device may be 10% to 40%.

Also, the inter-roll gaps of the calendering device may be independently 70 μm or more and 200 μm or less.

Also, the diameters of each of the plurality of rolls may independently be 200 μm to 300 μm.

The calendering device may be described the same as the method for preparing a dry electrode sheet for a secondary battery as for the description the same as that of the method for preparing a dry electrode sheet for a secondary battery.

### EMBODIMENT

In the description below, embodiments may be additionally described with reference to specific experimental examples. The embodiments and comparative examples included in the experimental examples are merely examples of the present disclosure and do not limit the scope of the appended claims. It may be obvious to those skilled in the art that various changes and modifications may be made to the embodiments within the scope and technical idea of the present disclosure, and such changes and modifications may fall within the scope of the appended claims.

### Embodiment 1

97 weight % of natural graphite as a negative electrode active material, 1 weight % of carbon black as a conductive material, and 2 weight % of polytetrafluoroethylene (PTFE) as a binder were put into a blender and mixed at about 9000 rpm for about 7 minutes, thereby preparing a composition for preparing a dry electrode sheet. The prepared composition was observed with an electron microscope, and the image is presented in FIG. 2. As indicated in FIG. 2, the negative electrode active material, conductive material, and binder were evenly distributed in the prepared composition.

As shown in FIG. 1, in a calendering device in which rolls from the first roll to the fifth roll are positioned in sequence, the prepared composition was put in between the first roll and the second roll to prepare a first electrode sheet, was put in between the second roll and the third roll to prepare a second electrode sheet, was put in between the third roll and the fourth roll to prepare a third electrode sheet, and was put in between the fourth roll and the fifth roll to prepare an electrode sheet (negative electrode sheet).

In this case, the temperature of each roll was approximately 80° C., and the velocity ratios of the two rolls adjacent to each other were both 40%. Also, the first inter-roll gap (G1) between the first roll and the second roll was 200 μm, the second inter-roll gap (G2) between the second roll and the third roll was 140 μm, the third inter-roll gap (G3) between the third roll and the fourth roll was 100 μm, and the fourth inter-roll gap (G4) between the fourth roll and the fifth roll was 70 μm.

The thickness of the prepared electrode sheet was measured using the method as below, and the results are listed in Table 1.

The thickness of the prepared electrode sheet was measured using a vernier caliper, and the thickness was measured at three points prepared by dividing the width of the electrode sheet into four regions, and the average value is listed in Table 1.

### Embodiment 2

Prepared in the same manner as embodiment 1, but the velocity ratios of the two rolls adjacent to each other were both determined to be 25%.

The thickness of the prepared electrode sheet was measured, and the results are listed in Table 1.

### Embodiment 3

Prepared in the same manner as embodiment 1, but the velocity ratios of the two rolls adjacent to each other were both determined to be 10%.

The thickness of the prepared electrode sheet was measured, and the results are listed in Table 1.

### Embodiment 4

Prepare in the same manner as embodiment 1, but the gap (G2) between the second roll and the third roll was determined to be 170 μm, the gap (G3) between the third roll and the fourth roll was determined to be 144 μm, and the gap (G4) between the fourth roll and the fifth roll was determined to be 122 μm, and the results are listed in Table 1.

### Embodiment 5

Prepared in the same manner as embodiment 1, but the gap (G2) between the second roll and the third roll was determined to be 110 μm, the gap (G3) between the third roll and the fourth roll was determined to be 60 μm, and the gap (G4) between the fourth roll and the fifth roll was determined to be 33 μm, and the results are listed in Table 1.

### Comparative Example 1

Prepared in the same manner as embodiment 1, but the velocity ratios of the two rolls adjacent to each other were both determined to be 50%. In this case, slipping occurred during the calendering process, and accordingly, the electrode sheet was not able to be obtained.

### Comparative Example 2

Prepared in the same manner as embodiment 1, but the velocity ratios of the two rolls adjacent to each other were both determined to be 8%. In this case, during the calendering process, the electrode sheet was broken by the roll, and accordingly, the electrode sheet was damaged, and the electrode sheet was thus not able to be obtained.

### Comparative Example 3

Prepared in the same manner as embodiment 1, but the temperature of each roll was determined to be approximately 50° C., and the velocity ratios of the two rolls adjacent to each other were both determined to be 8%. In this case, during the calendering process, the electrode sheet was broken by the roll, and accordingly, the electrode sheet was damaged, and the electrode sheet was thus not able to be obtained.

### Comparative Example 4

Prepared in the same manner as embodiment 1, but the temperature of each roll was determined to be approximately 120° C., and the velocity ratios of the two rolls adjacent to each other were both determined to be 50%. In this case, during the calendering process, the electrode sheet adhered to the roll, and accordingly, the electrode sheet was not able to be obtained.

### Comparative Example 5

Prepared in the same manner as embodiment 1, but the gap (G2) between the second roll and the third roll was determined to be 100 μm, the gap (G3) between the third roll and the fourth roll was determined to be 50 μm, and the gap (G4) between the fourth roll and the fifth roll was determined to be 25 μm. In this case, during the calendering process, the electrode sheet was broken by the roll, and the electrode sheet was damaged, and accordingly, the electrode sheet was not able to be obtained.

### Comparative Example 6

Prepared in the same manner as embodiment 1, but the gap (G2) between the second roll and the third roll was determined to be 180 μm, the gap (G3) between the third roll and the fourth roll was determined to be 162 μm, and the gap (G4) between the fourth roll and the fifth roll was determined to be 146 μm. In this case, slipping occurred during the calendering process, and the electrode sheet was thus not able to be obtained.

TABLE 1

| | | | | Self-standing | |
|---|---|---|---|---|---|
| | Roll | Velocity | G1/G2/ | electrode | |
| | temperature | ratio(%) | G3/G4(μm) | thickness(μm) | Notes |
| Embodiment 1 | 80° C. | 40 | 200/140/ | 105 | |
| | | | 100/70 | | |
| Embodiment 2 | 80° C. | 25 | 200/140/ | 118 | |
| | | | 100/70 | | |
| Embodiment 3 | 80° C. | 10 | 200/140/ | 135 | |
| | | | 100/70 | | |
| Embodiment 4 | 80° C. | 40 | 200/170/ | 152 | |
| | | | 144/122 | | |
| Embodiment 5 | 80° C. | 10 | 200/110/ | 102 | |
| | | | 60/33 | | |
| Comparative | 80° C. | 50 | 200/140/ | — | Slipping |
| example 1 | | | 100/70 | | occurred |
| Comparative | 80° C. | 8 | 200/140/ | — | Breakage |
| example 2 | | | 100/70 | | occurred |
| Comparative | 50° C. | 8 | 200/140/ | — | Breakage |
| example 3 | | | 100/70 | | occurred |
| Comparative | 120° C. | 50 | 200/140/ | — | Roll adhesion |
| example 4 | | | 100/70 | | occurred |
| Comparative | 80° C. | 40 | 200/100/ | — | Breakage |
| example 5 | | | 50/25 | | occurred |
| Comparative | 80° C. | 40 | 200/180/ | — | Slipping |
| example 6 | | | 162/146 | | occurred |

As indicated in Table 1, in embodiments 1 to 3, the reduction ratio of the inter-roll gaps was about 30% for G1 and G2, about 28.57% for G2 and G3, and about 30% for G3 and G4. The electrode sheets were prepared under the calendering process conditions of 5 embodiments 1 to 3, and the thicknesses of the prepared electrode sheets were 105 μm, 118 μm, and 135 μm, respectively.

Also, in embodiment 4, the reduction ratio of the inter-roll gaps was about 15% for G1 and G2, about 15% for G2 and G3, and about 15% for G3 and G4. The electrode sheets were prepared under the calendering process conditions of embodiment 4, and the thickness of the prepared electrode sheets was 152 μm. In embodiment 5, the reduction ratio of the inter-roll gaps was about 45% for G1 and G2, about 45% for G2 and G3, and about 45% for G3 and G4. The electrode sheet was prepared under the calendering process conditions of embodiment 5, and the thickness of the prepared electrode sheet was 102 μm.

Differently from the embodiments, in comparative example 1, the velocity ratio was about 50%, and slipping occurred during the calendering process, such that the electrode sheet was not able to be prepared. In comparative example 2, the velocity ratio was about 8%, and the electrode sheet was damaged during the calendering process, such that the electrode sheet was not able to be prepared. In comparative example 3, the velocity ratio was about 8%, the roll temperature was about 50° C., and the electrode sheet was damaged during the calendering process, such that the electrode sheet was not able to be prepared. Also, in comparative example 4, the velocity ratio was about 50%, the roll temperature was about 120° C., and the electrode sheet adhered to the roll during the calendering process, such that the electrode sheet was not able to be prepared.

Also, in in comparative example 5, the reduction ratio of the inter-roll gaps was about 50% for G1 and G2, about 50% for G2 and G3, and about 50% for G3 and G4. Since the reduction ratio of the inter-roll gaps was 50% or more, the pressure was not evenly applied to the composition for preparing the electrode sheet, such that at least a portion of the electrode sheet was damaged, and the electrode sheet was thus not able to be prepared.

Also, in comparative example 6, the reduction ratio of the inter-roll gaps was about 10% for G1 and G2, about 10% for G2 and G3, and about 10% for G3 and G4. When the reduction ratio of the inter-roll gaps did not exceed 10%, sufficient pressure was not applied to the composition for preparing the electrode sheet, such that slipping occurred during the calendering process, and the electrode sheet was thus not able to be prepared.

The descriptions described above are merely examples of applying the principles of the present disclosure, and other components may be further included within a scope not exceeding the scope of the present disclosure.

As described above, according to the method for preparing a dry electrode sheet for a secondary battery of the present disclosure, a calendering transfer defect due to slipping and roll adhesion during the calendering process may be prevented, and an electrode sheet having a good range of self-standing thickness may be prepared.

According to the aforementioned preferable embodiments, by using the method for preparing a dry electrode sheet for a secondary battery, as a solvent drying process is not included, such that improved process efficiency may be obtained.

Also, the method for preparing a dry electrode sheet for a secondary battery according to the preferable embodiment may implement the thickness of a self-standing electrode through a calendering process.

Also, the method for preparing a dry electrode sheet for a secondary battery according to the preferable embodiment may prevent a calendering transfer defect such as slipping, breakage and roll adhesion during the calendering process. Also, the method for preparing a dry electrode sheet for a secondary battery according

to the preferable embodiment may not include an electrode coating process and a drying process, such that the process may be simplified, facility investment costs and facility operating costs may be reduced, and the building area required for facility may be reduced.

Also, the dry electrode sheet for a secondary battery, the electrode for a secondary battery and the secondary battery according to the preferable embodiment may be widely applied in green technology fields such as an electric vehicle, a battery charging station, and a solar power generation and wind power generation using batteries. Also, the dry electrode sheet for a secondary battery, the electrode for a secondary battery and the secondary battery of the present disclosure may be used in an eco-friendly electric vehicle, a hybrid vehicle, or the like, for preventing climate change by suppressing air pollution and greenhouse gas emissions.

Only specific examples of implementations of predetermined embodiments are described. Variations, improvements and enhancements of the disclosed embodiments and other embodiments may be made with respect to the disclosure of this patent document.

What is claimed is:

1. A method for preparing a dry electrode sheet for a secondary battery, the method comprising:
preparing a dry electrode sheet by allowing a composition for preparing a dry electrode sheet, including an electrode active material and a binder, to pass through a calendering device,
wherein the calendering device includes a plurality of rolls,
wherein the calendering device has two or more inter-roll gaps (G) provided by two rolls (Ra and Rb) adjacent to each other among the rolls, through which the composition passes sequentially,
wherein the two rolls (Rna and Rnb) adjacent to each other and providing the nth inter-roll gap (Gn) have a velocity (V) ratio of 10% or more to less than 50%, represented by Equation (1):
$$Velocity ratio = [ V ( R n a ) - V ( R n b ) ] \times 100 / V ( R n b ) \qquad [ Equation ( 1 ) ]$$
where Rna indicates a roll further from a point at which the composition is injected, and Rnb indicates a roll closer to a point at which the composition is injected, wherein, as for the nth inter-roll gap (Gn) and the n+1th inter-roll gap (Gn+1), a reduction ratio between Gn and Gn+1 represented by Equation (2) as below is more than 10% to less than 50%:
$$Reduction ratio between Gn and Gn + 1 = [ ( G n ) - ( G n + 1 ) ] \times 100 / Gn \qquad [ Equation ( 2 ) ]$$
where Gn indicates an inter-roll gap provided on a side closer to a point at which the composition is injected, and Gn+1 indicates an inter-roll gap provided on a side farther from a point at which the composition is injected.

2. The method of claim 1, wherein a temperature of the rolls is greater than 50° C. and less than 120° C.

3. The method of claim 1, wherein the velocity ratio is 10% to 40%.

4. The method of claim 1, wherein the inter-roll gaps of the calendering device are independently 70 μm or more and 200 μm or less.

5. The method of claim 1, wherein a diameter of each of the plurality of rolls is independently 200 μm to 300 μm.

6. A dry electrode sheet for a secondary battery prepared by the preparing method in claim 1.

7. The dry electrode sheet of claim 6, wherein the electrode sheet has a thickness of 100 μm to 200μ m.

8. A calendering device for preparing a dry electrode sheet for a secondary battery, the calendering device comprising a plurality of rolls, wherein the dry electrode sheet is prepared by allowing a composition for preparing a dry electrode sheet, including an electrode active material and a binder, to pass through the plurality of rolls,
wherein the calendering device has two or more inter-roll gaps (G) provided by two rolls (Ra and Rb) adjacent to each other among the rolls, through which the composition passes sequentially,
wherein the two rolls (Rna and Rnb) adjacent to each other and providing the nth inter-roll gap (Gn) have a velocity (V) ratio of 10% or more to less than 50%, represented by Equation (1):
$$Velocity ratio = [ V ( R n a ) - V ( R n b ) ] \times 100 / V ( R n b ) \qquad [ Equation ( 1 ) ]$$
where Rna indicates a roll further from a point at which the composition is injected, and Rnb indicates a roll closer to a point at which the composition is injected, wherein, as for the nth inter-roll gap (Gn) and the n+1th inter-roll gap (Gn+1), a reduction ratio between Gn and Gn+1 represented by Equation (2) as below is more than 10% to less than 50%:
$$Reduction ratio between Gn and Gn + 1 = [ ( G n ) - ( G n + 1 ) ] \times 100 / Gn \qquad [ Equation ( 2 ) ]$$
where Gn indicates an inter-roll gap provided on a side closer to a point at which the composition is injected, and Gn+1 indicates an inter-roll gap provided on a side farther from a point at which the composition is injected.

9. The calendering device of claim 8, wherein a temperature of the rolls is greater than 50° C. and less than 120° C.

10. The calendering device of claim 8, wherein the velocity ratio is 10% to 40%.

11. The calendering device of claim 8, wherein the inter-roll gaps of the calendering device are independently 70 μm or more and 200 μm or less.

12. The calendering device of claim 8, wherein a diameter of each of the plurality of rolls is independently 200 μm to 300 μm.
